(19) United States
(12) Patent Application Publication
(10) Pub. No.: US 2023/0152106 A1
(43) Pub. Date: May 18, 2023

(54) TERRAIN-BASED VEHICLE NAVIGATION AND CONTROL

(71) Applicant: ClearMotion, Inc., Billerica, MA (US)

(72) Inventors: Marco Giovanardi, Melrose, MA (US); William Graves, Somerville, MA (US); Zackary Martin Anderson, Cambridge, MA (US)

(73) Assignee: ClearMotion, Inc., Billerica, MA (US)

(21) Appl. No.: 17/920,628

(22) PCT Filed: Apr. 22, 2021
(86) PCT No.: PCT/US2021/028710

§ 371 Date: Oct. 21, 2022

Related U.S. Application Data
(60) Provisional application No. 63/014,210, filed on Apr. 23, 2020.

(51) Int. Cl. G01C 21/34

(52) U.S. Cl. CPC G01C 21/3461; G01C 21/3492

(57) ABSTRACT

Various systems and methods are disclosed for providing a broad range of tools for selecting a route based on road information, vehicle information, and vehicle occupant information. Also disclosed are costs and tradeoffs which may be associated with various choices including wear and tear on vehicle components, occupant discomfort, increased trip duration and efficiency losses.

### RELATED APPLICATIONS

This application claims the benefit under 35 U.S.C. § 119(e) of U.S. provisional application No. 63/014,210, filed Apr. 23, 2020, the disclosure of which is incorporated herein by reference in its entirety.

### FIELD

Disclosed embodiments are related to vehicular control and route selection based at least partially on road surface information, vehicle information, and vehicle occupant information collected while traversing a road surface.

### BACKGROUND

GNSS based navigation systems in use today may recommended one or more routes for reaching a destination. Such systems may indicate the fastest route for traveling to a destination, allow a driver to select the desired route and instruct a driver about what roads to take to reach the desired destination.

### SUMMARY

Various systems and methods are disclosed for providing a broad range of tools for selecting a route based on road information, vehicle information, and vehicle occupant information.

According to aspects of the disclosure, there is provided a method of operating a vehicle that includes receiving information about two or more routes between a first location and a second location; receiving vehicle-specific information about the vehicle; based at least partially on the information received, selecting a route from among the two or more routes; and traveling along the selected route by driving or autonomously operating the vehicle. In some embodiments, some of the two or more routes may at least partially overlap with each other. In some embodiments, some of the information received may include information about the road surfaces of at least portions of the two or more routes. In some embodiments, the received information may include data from a GNSS (e.g., GPS) and/or a terrain-based localization system about the location of the vehicle. In some embodiments, the first location may be the current location of the vehicle and the second location may be the destination of the vehicle. In some embodiments, the vehicle may be an autonomous vehicle, a semi-autonomous vehicle, and a manually driven vehicle. the information received may include information about or the output of a transfer function of a suspension system of the vehicle. In some embodiments, the suspension system of the vehicle may be an active suspension system. In some embodiments, the information received may include information about the position of a center of gravity of the vehicle. In some embodiments, the information received may include information about the projected speed of the vehicle. In some embodiments, the information received may include information about the projected or anticipated speed of the vehicle when traveling along at least a portion of the two or more routes. In some embodiments, the method may include: determining projected road induced disturbances when traversing the two or more routes, at least partially based on the received road-surface information and the projected speed of the vehicle on at least portions of those routes, and then selecting or recommending a route at least partially based on the information about the induced disturbances. In some embodiments, information received about the vehicle may include the vehicle's weight, information about a vehicle occupant (e.g., information about the sensitivity of the at least one vehicle occupant to motion sickness, information about the sensitivity of the at least one vehicle occupant to motion sickness while performing an activity (e.g., reading, manipulating a computer mouse, etc.), and/or information about a projected activity by the at least one vehicle occupant. In some embodiments, a speed range is determined for a selected route based at least partially on the information received about the road, the vehicle and/or the vehicle occupants. The vehicle is then operated, within the determined speed range, on at least a portion of the selected route.

According to aspects of the disclosure, there is provided a method of operating a vehicle that includes receiving information about at least two routes between a first location and a second location; receiving information from a user interface; selecting a route from among the at least two routes, wherein the selection is based at least partially on the information received about the route and via the user interface; and traveling along the selected route, with the vehicle (e.g., manually driven or autonomous vehicle). In some embodiments, the user interface may be located on-board the vehicle. In some embodiments, the information received from the user interface may include: an indication that reduction of tire-wear is a preference or priority, that reduction of motion sickness in a vehicle occupant is a preference or priority, that reduction of lateral acceleration of the vehicle body is a preference or priority, and/or that reduction of vertical acceleration of the vehicle body is a preference or priority. In some embodiments, the method may include selecting a speed for at least a portion of the selected route based at least in part on the information received about the road and from the user interface. In some embodiments, the method may include selecting a maximum speed for at least a portion of the selected route based at least in part on the information received about the road and the user interface. In some embodiments, the method may include selecting or determining a minimum speed while traveling along at least a portion of the selected route based at least in part on the information received about the road and the user interface. In some embodiments, the method may include selecting a lane in a multilane portion of the selected route. In some embodiments, the information received about the road may include road-surface information. In some embodiments, the information received about the road may include crowd-sourced information.

According to aspects of the disclosure, there is provided a method of operating a vehicle that includes receiving information about at least two routes between a current location and a destination; receiving vehicle-specific information about the vehicle; based on the route and vehicle information, selecting a route from among the at least two routes to achieve less component wear, less motion sickness, shorter travel time, and/or higher energy efficiency; and traveling along the selected route selected.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various nonlimiting embodiments when considered in conjunction with the accompanying figures.

### BRIEF DESCRIPTION OF DRAWINGS

FIG. 1 is a schematic representation of one embodiment of a controller system of a vehicle.

### DETAILED DESCRIPTION

The inventors have recognized that navigation systems and/or one or more microprocessor-based controllers on-board a vehicle may be used to provide data, in addition to location data, to a user. Such additional data may include, for example, travel time, tolls, and other factors. This additional data may, for example, be provided to an operator (e.g., vehicle driver, vehicle occupant, and/or autonomous vehicle controller) in combination with road surface data. This additional data may include, for example, road content, road features, and various other road characteristics. The Inventors have further recognized that one or more microprocessor-based controllers on-board a vehicle may receive data, from on-board or remote data-bases, which may include, for example:
(i) vehicle-specific localization data (i.e., data about or indicative of the location of the vehicle) which may be derived from terrain-based information and/or GNSS (Global Navigation Satellite Systems);
(ii) vehicle-specific information about, e.g., the state of the vehicle, for example, including vehicle mass or weight, vehicle suspension transfer function, location of the center of gravity, type/model of various components such as tires, dampers, bushings, and/or degree of wear of various components;
(iii) vehicle-specific information about, for example, one or more vehicle occupants, such as for example, occupant preferences, age, fatigue level, level of driving skills, and/or sensitivity to motion sickness;
(iv) vehicle-specific information about an activity one or more vehicle occupants may be engaged in;
(v) road specific information about the road selections available to the vehicle, including information about road surface anomalies or abnormalities (e.g., potholes, bump, cracks, storm grates, expansion joints) and/or about snow and/or ice cover on the road surface;
(vi) road specific road geometry information, such as for example, road camber, road slope, elevation, and/or curvature;
(vii) road specific information about risk factors, such as for example, likelihood of rockslides, flooding, accidents, which may be a function of the time of day, weather conditions, visibility or seasons; and/or
(viii) weather data which may include projected or measured local temperature and/or precipitation data.

In some embodiments, based on some or all such data, one or more controllers, which may include one or more microprocessors, may be used to provide information or recommendations that may assist a driver and/or vehicle controller. Such information may include, for example, a recommended road, route and/or lane selection, and/or travel speed. Such information may be used by one or more controllers to operate one or more vehicle systems such as, for example, advanced driver-assistance, active or semi-active suspension, braking, propulsion, and/or steering systems.

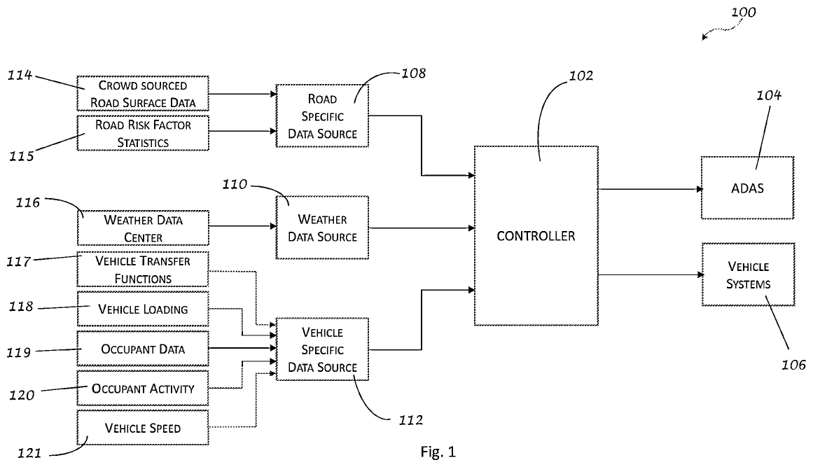

FIG. 1 illustrates a vehicle control system 100 that includes a microprocessor-based controller 102 that may be used to provide information or recommendations to a diver via an Advanced Diver-Assistance System (ADAS) 104 or to various other vehicle systems 106, such as for example, an autonomous vehicle controller, an active or semi-active suspension system, a braking system, a stability control system, and/or a steering system. The information and recommendations provided by the controller 102 may be based on information from various on-board or remote sources, such as for example: a road specific data source 108 which may provide information, including road surface data and/or risk factor information such as accident statistics; a weather data source 110, which may include local temperature, precipitation and/or visibility data; and a vehicle-specific data source 112, which may include information about the vehicle such as the make, model and operating characteristics of various systems (e.g., transfer functions, vehicle loading, center of gravity, vehicle dynamics, current state of various systems (e.g., wear state of tires and/or dampers)), and/or information about one or more vehicle occupants (e.g., sensitivity to motions sickness, driving skills, and/or activity type). These data sources may receive information from on-board or remote data bases (e.g., cloud-based) and/or sensors 114-121. Such sensors may be located on-board the vehicle, on-board other vehicles or may be part of the infrastructure.

In some embodiments, a crowd-sourced road terrain mapping system may be used to create High Definition (HD) maps that may include road contour, road curvature, road classification, and road events information in addition to other information, such as, for example, travel time, tolls etc. The system may acquire road information from connected vehicles with sensor sets including sensors or sensor systems such as, for example, GPS, vehicle speed sensors, accelerometers, and/or various other vehicle-based sensors that may vary from vehicle to vehicle. In some embodiments, the system may calculate terrain information, such as for example, road contour frequency content, road camber, road characteristics, and road events such as potholes, speedbumps, cracks, swells, and other road surface features, anomalies or abnormalities, and also road curvature in, for example, an in-plane direction (e.g., around the vertical axis of the vehicle, corresponding to the yaw direction). In some embodiments, collating information from various vehicles may be used to create an HD-map that includes this additional information such as, for example, map metadata for one or more road segments.

In some embodiments, information about the road content, road quality and/or condition may be derived from the HD maps and/or from other related or unrelated sources such as weather information, local municipality information, web resources, user reporting, other vehicles (V2V), and/or user feedback.

In some embodiments, such additional information may be used to provide the navigation system and/or other on-board system(s) with additional inputs to, for example, improve route and/or speed selection. As a result, this optimization may be based on variables including travel time but, also on a broader range of variables, depending on the use case, that may be relevant to the specific user. In some embodiments, by using such additional information in combination with other parameters it may be possible to create route navigation that is customized to the end user, e.g., end user vehicle, and/or end user vehicle occupant or driver. Multiple factors related to the road content may be used, and in some embodiments, may be combined to provide an individualized and/or customized route guidance or to provide additional information to the end user.

For example, the road content, in terms of spatial frequency content, may impact the vehicle in a manner that is proportional to the vehicle's speed. For example, a 10 m long wave on the road surface may create a 1 Hz input or disturbance if the vehicle is travelling at 10 m/s, but a 3 Hz input if the vehicle is travelling at 30 m/s. At a slow speed, this particular wave may, for example, excite vehicle body natural frequencies, such as for example in the range of 1.0 to 1.5 Hz, and thus be felt as a large input, while at a higher speed, e.g., highway speeds, the same wave may excite the mid-frequencies, for example in the range between 1.5 Hz and 5 Hz or higher. At such higher frequencies, some vehicles may more effectively isolate inputs or disturbances, and thus the road input may be perceived or sensed as a smaller or less significant disturbance by a vehicle occupant.

In some embodiments, a vehicle or various vehicle systems may have a response to certain road inputs that may be defined, measured, or estimated, and that may vary with time, environment, parameter settings, and environmental factors such as temperature, humidity, or air pressure. Examples of such systems may include suspension system components, e.g., dampers and/or bushings, which may behave differently as a function of temperature or age; tires, which behave differently with degree of wear, temperature, humidity and the presence of snow, ice or rain; as well as other systems such as the engine mount bushings, or systems such as the engine exhaust or catalytic converter systems. Knowledge of such responses, which may be referred to as a vehicle's transfer functions, or approximate transfer functions, may be used to estimate how a given road input will affect the vehicle and the occupants in terms of comfort and/or in terms of its impact on the vehicle's handling, comfort, durability and/or the durability of one or more components of a vehicle.

In some embodiments, a linear transfer function may be based on a linearized response of a system and may be used to estimate the response of a system to a given input or set of inputs while ignoring nonlinear effects. Linear transfer functions may be used to estimate the operation of nonlinear systems by linearizing the response around an operating point. Multiple linearized responses may be used at multiple operating points to estimate response over a wide range where the response is nonlinear overall. For example, inputs at or near a vehicle's body resonant frequencies (for example, for some vehicles in the range of 1.0 Hz to 1.5 Hz for a front or rear axle, a frequency of 1.2Hz for a front axle, a frequency of 1.4 Hz for a rear axle, a frequency in the range of 2 Hz to 3 Hz in the roll direction, or a frequency of 2.5 Hz in the roll direction) may cause the vehicle to exceed its suspension travel due to suspension excursions caused by road disturbances, and thus may degrade suspension components, for example, by engaging the suspension bump or rebound stops, or by overloading the tire during the event. However, body resonant frequencies both above and below the above indicated range are contemplated, as the disclosure is not so limited.

In some embodiments, the response or transfer function may be different for different input directions. For example, in the roll direction (which may be excited by road content that is different on the left and right side of the vehicle), twist direction (which may be excited when at least a part of the road input follows a pattern where the road under one front wheel and a diagonally opposed rear wheel moves in the same direction, and the other two tires are out of phase and move in the opposite direction), heave direction (which may be excited when at least part of the road input applies equally to all four wheels), and pitch direction (which may be excited by road content that at least partially moves the front wheels in the opposite direction from the rear wheels), or any combination of these directions. The directionality of the transfer function may be described in various combinations and the description here is not limited to the described combinations. It is understood that other directions and combinations of directions may be defined, as the disclosure is not so limited.

In some embodiments, road contour information may be used to estimate wear and tear on one or more set of vehicle components, such as for example the tires, the suspension dampers, or the steering system, among others. Rough roads may increase the wear and tear on vehicle components and may lead to higher repair costs over the life of a vehicle and also increase the chances of catastrophic failure. Roads with various surface anomalies or abnormalities, such as for example, potholes or speedbumps may also contribute to such degradation. Such degradation may be determined and/or predicted, for example, based on historical data for a given vehicle type, or may be provided by the vehicle manufacturer as guidance. In some embodiments, for example, a tire manufacturer may qualify tires for a certain number of road miles on good roads, for example qualified as having an international roughness index (IRI) of 1.5 m/km or less, or for a lower number of rough road miles, for example qualified as having an IRI of 2.5 m/km or more. Other road roughness or road quality indexes and ranges both above and below those mentioned above are contemplated, as the disclosure is not so limited.

In some embodiments, damper lifetime may be determined or computed by conducting endurance testing in a laboratory. For example, sample dampers may be exposed to a predefined test sequence or sequences that may include high velocity events, for example in the range of 2-3 m/s to determine their expected failure rate. However, velocity ranges both above and below 2-3 m/s are contemplated, as the disclosure is not so limited. The number of events that a damper model may experience before failing may be used to estimate its life span. In some embodiments, such information may be used to determine or predict the degree of degradation of a damper, of the same model, if a vehicle with such a damper is operated over a particular route.

In some embodiments, a navigation system may add up the miles of good, fair, and rough road to be traversed, and scale them with respect to tire life or damper life or the life of another component. In some embodiments, a user selected setting may establish the importance of the life of one or more components, for example tire life, to a given user. In some embodiments, a setting may establish a level of importance associated with a component, e.g., a tire, based on an estimated remaining useful life such a component. For example, a tire manufacturer may specify the useful life of a tire to be 50,000 miles on good roads, or 40,000 miles on fair roads, or 20,000 miles on poor roads based on an appropriate strategy for ranking of roads as poor, fair and good, e.g., based on the associated IRI of a road. For example, if a tire is driven for 10,000 miles on poor roads and 20,000 miles on good roads, then the useful estimated remaining life may be 10% (determined by using the equation (100−100*(10,000/20,000+20,000/50,000)) and comparing it to 100%). In some embodiments, for example, a system, a remote or on-board microprocessor-based controller, may automatically select or recommend a longer but better route to save tire life or, alternatively, a shorter but poorer quality road to save time.

Additionally or alternatively, in some embodiments, wear models of other components, such as for example, suspension or chassis, components may be used to predict the life of a component as a function of road parameters. In some embodiments, the expected life models may be a function of, for example, road content in a given frequency range. It is noted that the road content may be defined as a function of distance travelled, and that the conversion to frequency (meaning, as a function on time) may be a function of actual or expected travel speed.

In some embodiments, a wear model may be a function of events such as pothole strikes. In some embodiments, a component's (or the vehicle's) wear model may include susceptibility to certain parameters, for example to the size of potholes encountered and the speed of the vehicle at the time of encounter. Such wear models may be used to estimate the total damage to a given component based on the number of a given type of events encountered and/or the speed of the encounter. Each event encounter may be assigned a severity score based on parameters associated with the events in an HD map and the speed of the vehicle, and/or based on measurements, for example, of acceleration or force, using vehicle-based sensors. In some embodiments, estimates of damage to one or more components from traversing a given road segment may be used to provide more informed navigation guidance. For example, a navigation path that may encounter several large and/or unavoidable potholes may be less preferred than a navigation path that leads to longer travel time but minimizes encounters with adverse road events, such as for example potholes. In some embodiments, component damage or failure models may be used to predict the probability of a catastrophic failure. Damage or failure models may be based on, for example, the determination and tracking of actual stresses or strains a component is exposed to, empirical simulations that relate wear or damage to exposure to various stresses (which may, for example, include crowd sourced wear data for the same or similar components, for example, in the same or similar model vehicles) and/or manufacturer recommendations or specifications.

In some embodiments, a level of discomfort induced by road inputs may be considered, for example, by using comfort models. In some embodiments, road inputs that may be considered may include, for example, interactions with potholes, speed bumps, and or road undulations, as a function of the predicted driving speed. Such factors may materially decrease occupant comfort or perceived comfort. In some embodiments, information about vehicle type and driving speed, along with the road input, may be considered to create a general comfort or discomfort metric. In some embodiments, a user may prefer to choose roads and speeds that best suit their current state and/or their desired comfort level.

In some embodiments, another factor that may be considered is fuel or electrical energy consumption. Different road types, and especially different road profiles, may lead to different fuel or energy consumption. In some embodiments, a navigation or vehicle control system may use road profile information to refine the expected fuel consumption and use that information in providing optimal route guidance.

In some embodiments, motion sickness may be considered when making route selections or recommendations. The likelihood or anticipated severity of motion-sickness on a certain road at anticipated or planned speeds may be used to refine the route selection or recommendation process. In some embodiments, this process may consider the susceptibility of one or more occupants of a vehicle. In some embodiments, the consideration or weight given to motion sickness for route selection or recommendation, in addition to road type or profile, may also depend on the identity of the occupants, information about their susceptibility to motion sickness, and/or the activities they are or may plan to be involved in. In some embodiments, a motion sickness model may be based on empirical data collected on similar roads and anticipated speeds for a given vehicle occupant. If the occupants of a vehicle are known not to be susceptible and/or do not plan to be or are not engaged in activities such as reading, then motion sickness may not be considered or may be given little or no weight. However, if one or more occupants are susceptible to motion sickness, motion sickness may be given added weight.

In some embodiments, this information about motion sickness susceptibility, along with, for example, information on current traffic status and therefore likely traversal speed, may be used to assign a relative motion sickness score to each segment of a proposed route. Such information may be used to optimize the route for a combination or a subset of travel time, fuel consumption, and other factors such as for example the propensity of the proposed route, given the sensitivity of one or more occupants, to induce motion sickness. In some embodiments, if the driver of the vehicle is the only occupant, and since it is recognized that the propensity of the driver to feel motion sickness is low, this component of the optimal route selection may be discounted. It is also noted that if the vehicle is a shared or autonomous vehicle where the occupant is not driving, the occupant may prefer to trade a reduction in motion sickness for an increase in other factors, such as for example travel time, fuel consumption, or general comfort. In some embodiments, a vehicle may include a user interface where vehicle occupants may declare their preferences, such as for example, a ranking of the importance of factors such as component wear, comfort, motion sickness mitigation, fuel economy, trip duration, and/or safety. In some embodiments, the ranking of the importance of such factors may be performed completely or partially by a microprocessor-based controller.

In some embodiments, special vehicle characteristics, such as the low ground clearance of a sports car, may be considered in route selection or recommendation. Route guidance for such vehicles may consider the road content and the types of events to be encountered, as vehicles with low ground clearance may be more prone to damage by, for example, sharp road surface transitions or speed bumps, and vehicles with low profile tires may be more likely to be damaged by, for example, potholes. With a map layer that includes such road surface information, in some embodiments, route selection or recommendation may be at least partially customized for a given vehicle or vehicle type. Such selection may be based on a road rating for each type or class of vehicle.

The Inventors have further recognized that the curvature of a road segment may be useful information for the control of vehicles and vehicle systems. In some embodiments, when a vehicle may be traversing a road segment, the curvature of a road segment may be estimated or determined by using crowd sourced data collected from a plurality of vehicles and/or during multiple trips over that road segment by a single vehicle. As used herein, the term “road curvature” refers to the curvature in the direction parallel to the road surface, which is normally associated with the “yaw” degree of freedom of a vehicle travelling on the road segment. Road curvature may be used to determine the in-plane trajectory that a vehicle may traverse in order to follow the road. Its value may be used to assess the input that a driver (or autonomous vehicle controller) may provide as well as determining any deviation from this input. As used herein, the term “average road curvature at a point” refers to the average curvature of the path taken by two or more instances of a vehicle traversing a given point on a road segment, in a given direction, without changing lanes or driving erratically. The average road curvature at a point may be calculated by collecting path and heading information from all or a subset of vehicles travelling on a given road segment over a given time period.

The Inventors have recognized that, in some embodiments, while calculating curvature may be possible from simple latitude and longitude information of a given road segment on a map, in practice this information may not typically be of sufficient quality, resolution, and/or accuracy to distinguish between actual and typical road segment transitions and sharp turns. For example, a road map may not take into account how actual vehicles may travel along a given road segment. For example, many sharp corners on a map may be significantly less sharp in reality, since drivers or autonomous controllers may “cut” the corners to, for example, reduce the lateral acceleration felt by the occupants at a given speed. In some embodiments, using a crowd-sourced method to record all or a subset of yaw rate, speed, and lateral acceleration for participating vehicles, traversing a given road segment, along with GPS information and/or other localization methods, an average vehicle heading may be determined, for example, at a subset of points along each road segment on a map. In some embodiments, an average heading may be determined by adding the sine of the heading angle of a given vehicle at a given location for a drive to the total sum of sines of heading angles for all or an appropriate subset of vehicles traversing the same location, and separately adding the cosine of the heading angle of a given vehicle at the same location for a given drive to the total sum of cosine angles of the heading angle of the vehicle or all or an appropriate subset of vehicles traversing at the same location, and then using the ratio of the sum of sines and the sum of cosines to calculate the average angle. This method may be equivalent to calculating the angle of the vector sum of the normalized heading vectors for each traversal or a selected subset of traversals of a given location of a road.

In some embodiments. having information about the average curvature in the road ahead allows the anticipated lateral acceleration to be estimated for any given speed and the optimal speed to be selected. This may be useful, for example, if a reduction in speed is necessary in order to properly navigate an upcoming turn, either because the expected lateral acceleration at the current speed may exceed a safety limit at the current road or weather conditions, and/or because the acceleration would exceed a comfort limit for the occupants, and/or because the change in acceleration may be perceived as too abrupt and thus create a perception of lack of safety or comfort. Alternatively or additionally, information about road curvature may be used to control body roll at a given speed, for example, by adjusting the damping rate of one or more semi-active dampers or by applying active or passive forces with one or more active suspension or active roll control actuators. In some embodiments, determining an optimal or desired speed may also be based on anticipated weather conditions at a turn. For example, the effect of ice, snow, rain, and/or wind may be considered. In some embodiments, access to road curvature and weather information may help choose the proper speed to avoid spinouts. Autonomous and/or driven vehicles may benefit from such information. In some embodiments, information about road curvature may also be used by a navigation system or control system in the selection or recommendation of a route.

In some embodiments, information about road curvature of a road segment ahead may be combined with information about road surface grip of one or more of a vehicle's tires to determine safe limits for the driving speed for a particular vehicle under a given set of road surface conditions. In some embodiments, the road surface grip information may be based on data from multiple sources, including for example measured quantities from a municipality's assessments of roads, crowdsourced information from previous vehicles' on-board grip estimators, information about road roughness (e.g., focused on roughness in the tire hop frequency of e.g. 12 Hz (or in the range 10-15 Hz) at a given driving speed), information about road surface alterations based on the recently traversed road segments, and/or based on crowd-sourced methods from vehicles that recently traversed the upcoming segment, that could indicate snow or ice on the road. Combining some or all of these information sources, along with a knowledge of the road curvature from, for example, a crowd-sourced method as described above, or even simply from a map of the road segment, and/or information about a vehicle, a maximum safe driving speed may be determined, with some margin in order not to induce the driver or autonomous operator to take excessive risk. In some embodiments, a control system may provide such information either indirectly (e.g., through warning lights, heads-up displays, or vehicle display functions, or for example on a phone app used for navigation) or directly (by communicating with the vehicles' computer responsible for controlling the speed, for example the cruise control system, the antilock braking system, the vehicle domain controller, or the drive controller in the case of an autonomous vehicle). This limit speed may be a more accurate representation of a maximum safe speed for a road segment than a posted speed limit as provided by road maintenance crews, municipality, or state authority in charge of a road. In some embodiments, this method may consider, for example, conditions that may change rapidly with location, weather, road roughness, and tire grip condition and/or be specific to a particular vehicle. For example, a recommended maximum speed, for example determined by a microprocessor-based controller, for a particular vehicle traversing a particular segment of road under a particular set of weather conditions may be based on information about the suspension system of that vehicle (as e.g., estimated by its transfer function), the condition of one or more of its tires, loading of the vehicle, and/or its center of gravity, and other factors.

It is noted that an expected lateral acceleration for a given road segment may depend on the driving speed. In cases where driving speed may be estimated fairly accurately based on speed limits and current traffic conditions, this allows for an estimate of the amount of lateral acceleration to be encountered on a given drive, which may be a factor both for general occupant comfort, and in terms of the likelihood of inducing motion sickness, as well as wear and tear on vehicle components, e.g., the tires, bushings and dampers. For example, if the choice is between a first route to a destination and a second route that includes segments with higher lateral acceleration than the first route, a preference may be given to the first route with less lateral acceleration even at the expense of, for example, an increase in travel time, in order to mitigate, for example, discomfort, motion sickness of occupants, and/or tire wear etc. In some embodiments, the selection or recommendation of a route and/or speed may also depend on the activity that one or more occupants may be involved in. For example, based on information that one or more occupants are or may be typing on a keyboard, using a computer mouse, and/or writing on paper, the vehicle speed and/or route may be selected to maintain lateral acceleration below a preset limit.

In some embodiments, certain vehicles (e.g., vehicles towing trailers, such as large trucks or personal vehicles towing recreational trailers, and vehicles with long wheelbase, such as recreational vehicles (RVs)) may be more severely challenged by sharp turns in a road. In some embodiments, advance notice may be provided to such vehicles and/or certain routes or sections of road may be avoided altogether. In some embodiments, navigation guidance and recommended speed limits for such vehicles or other vehicles challenged by sharp turns or elevated lateral acceleration for dynamic or comfort reasons may at least partially be based on the anticipated or predicted degree of lateral acceleration.

In some embodiments, the average curvature at a given point on a given road segment may also be used to estimate a lane departure or lane change accurately and with low latency, for example, by comparing the current curvature of the path followed by the vehicle to the average or expected curvature previously determined for that segment. This allows for an immediate or effectively immediate recognition of a deviation from the path as opposed to methods that recognize a lateral deviation from the path (such as for example methods based on visual recognition of lane markings, or methods based on recognizing the terrain of the road) because an initial step when changing lanes may be a change in the direction of travel before a lateral deviation has occurred. Frequently vision systems or other similar systems are unable to provide road curvature information, for example when visibility may be poor due to weather or lighting; when road signage may be insufficient or when the actual driving route most drivers take deviates from the signage on the road. For example, sensors that may be used to aid navigation may be hampered or rendered ineffective during poor weather conditions (e.g., fog or snow) and/or where there may be debris or dirt on the road and/or when faded or non-existent lane markings make lane recognition difficult. Using the current estimated heading of a vehicle and comparing it to the average heading (or using the current curvature and comparing it to the average curvature) allows for identification of any significant deviation from an expected path. For example, a significant deviation of the heading could deviate by 1-3 degrees or more, and the integral in distance of the heading deviation may be used to determine the resulting lateral offset, thus allowing the number of lanes traversed in a maneuver to be estimated. The same technique may also be applied to determine when a vehicle has a turned from one road on to another, or a vehicle may be entering an exit lane that may be parallel to the normal travel lane. Determining when a vehicle may be in an exit lane may be useful on highways where GPS resolution may be insufficient to recognize when a driver has entered an exit lane (or conversely, when the driver should have been in the exit lane but did not exit).

In some embodiments, information about a road segment (for example, the road profile, road curvature, road grip, and/or current weather conditions) may be used, along with information about the vehicle (for example, geometry, center of gravity, type, suspension system capability (e.g., transfer function) and/or dynamic capability), the vehicle components (for example, tire type and degree of wear and/or damper type and degree of wear) and other relevant information, to calculate one or more of a recommended average speed, a recommended instantaneous speed, a maximum recommended speed, and a minimum recommended speed.

A recommended speed may be useful as guidance to the driver, or as an input into an autonomous or semi-autonomous vehicle operating system or controller. For example, a recommended speed may deviate from the speed limit on a given road due to current road conditions (for example low grip due to rain or snow), type and condition of one or more tires of the vehicle (for example one or more highly worn tires), or road profile or road classification (for example, a road in poor state of repair or with small undulations that may cause lateral slip of the vehicle, or a road with a lot of low frequency swells which may cause a certain type of vehicle to lose lateral grip), or the type of vehicle (for example, a long wheelbase and/or high center of gravity vehicle such as a bus or SUV, which may have a lower safe lateral acceleration limit).

In some embodiments, a recommended maximum speed for a road segment may be below the posted speed limit on the road that the segment may be a part of, while a recommended minimum speed may be useful on road segments where the road content may be less objectionable or less prone to causing damage to a vehicle or discomfort to vehicle occupants when traversed at higher speed versus lower speed. For example, traversing speedbumps at too low a speed may cause exaggerated vertical motion resulting in, for example, discomfort and/or motion sickness, while traversing them at too high of a speed may cause, for example, damage to the vehicle or a component. Under such a circumstance, a speed range between a minimum desirable speed and maximum safe speed may be recommended. In some embodiments, information about the posted speed limit for a particular type of vehicle may be obtained, and the recommended maximum speed may be less than or equal to the posted speed. In some embodiments, the recommended maximum speed may additionally be a function of vehicle weight per axle such as to minimize damage to the road surface.

In some embodiments, a recommended speed may be based on the dynamics of the vehicle. Depending on the wheelbase and trackwidth of the vehicle, certain types of road input may be worse at some speeds than at others. For example, the wheelbase of the vehicle determines what spatial frequencies of inputs into the car create heave oscillations, where the vehicle moves up and down to a similar extent in the front and the back of the vehicle, or pitch oscillations, where the front and rear of the vehicle move out of phase. For example, a ground swell that may be significantly longer than the vehicle's wheelbase may excite primarily or only heave motion, while a ground swell that has a wavelength equal to twice the wheelbase may primarily induce pitch motion. The inventors have recognized that the frequency of the disturbance the vehicle may be exposed to, however, may be determined by the vehicle speed. Given the dynamics of the vehicle, there are therefore speeds that may excite, for example, heave, roll, or pitch resonances, or a combination of two or more types of resonances in the vehicle. For example, in some embodiments, a disturbance may excite the primary heave resonance of the vehicle at a particular speed or range of speeds, in which case the motion of the vehicle may be particularly objectionable. It may therefore be desirable to avoid driving at speeds that excite dynamics of the vehicle in any given direction of motion; for example, traversing a road with a lot of road content at wavelengths near the wheelbase of the given vehicle at a speed that causes an input frequency that excites the vehicle in a way that may be objectionable. In some embodiments, such speeds may be avoided when recommending a speed of travel. For example:
1. a first road segment may have a sinusoidal spatial road profile, with a wavelength of 6 meters, in common mode (meaning the road surface profile under the left and right side of the vehicle are similar).
2. a first vehicle may respond poorly to pitch inputs at 1.5 Hz, for example because of a dynamic resonance

If the first vehicle traverses the first road segment in the example above at a speed of Vx=20.1 mph=9 m/s, then the sine wave road described above would create a pitch input at a frequency f=9 m/s/6 m/cycle=1.5 cycles/sec=1.5 Hz. If the vehicle is sensitive to a pitch input frequency of 1.5 Hz, it may be desirable to avoid travelling along this first road at a speed at or near 20 mph. If the same vehicle was for example much less sensitive to pitch input at 3 Hz, then a driving speed of 40 mph, which would cause a pitch input at f=40*1.6/3.6/6=2.96 Hz, may be more desirable. At the same time, if a vehicle with a longer wheelbase of 4.5 m traversed the same road, it would not generate significant pitch input and may therefore be insensitive to this road segment's pitch content (while being sensitive to other content at a different driving speed, resulting in a different recommended, maximum recommended, or minimum recommended speed).

In some embodiments, effects of wheel imbalance may be mitigated by selecting the speed of the vehicle. Inventors have recognized that the wheels of a road vehicle rotate at a speed that may be calculated based on their effective rolling radius and the vehicle's forward speed. Due to tire dynamics, the effective rolling radius of a tire is generally slightly less than the actual free radius, but larger than the compressed radius of the tire. The radius of a fully inflated tire may, for example, be 338 mm; the height of the wheel center above ground once the vehicle weight is on it may be significantly less, for example 315 mm (this may be called the “compressed radius” of the tire), but the distance travelled by the wheel center for each full rotation of the hub may be 330 mm (whereby the effective radius of the tire may be approximately 52.5 mm). Under typical driving conditions when the vehicle is not accelerating, cornering, or decelerating, there may be little or no wheel slip, for example less than 1%. As used herein, the term “wheel slip” refers to the difference between the forward velocity of the vehicle and the product of the effective rolling radius of a wheel and the angular velocity of the wheel.

In some embodiments, the suspension in a given corner and the associated tire may be designed to have a resonant natural frequency, often called tire hop or wheel hop. This resonant frequency may be a characteristic of the system of unsprung mass (which in an independent suspension may be equal to the mass of the combination of a wheel and any associated moving components of the suspension that are kinematically linked to move, with the wheel, relative to the vehicle chassis and in a non-independent suspension may be defined according to the dynamics governing that type of suspension and the wheel). The Inventors have recognized that vehicle tires are lightly damped in the vertical direction (i.e., they do not dissipate large amounts of energy when being compressed and uncompressed by inputs applied by the road surface in a direction that may be normal to the road surface) in order to minimize energy loss during rolling, and thus largely and effectively act as a spring in the vertical direction. Therefore, the resonance of the unsprung mass in combination with the tire spring may be very pronounced, for example with a resonant peak that may be between 5 and 10 times greater than the underlying response, and at resonance, the wheels may be excited and caused to bounce by a significant amount when subject to inputs at or near the tire hop frequency, for example, at 12 Hz, or in the range of 10-15 Hz, for typical vehicles.

In some embodiments, tires and wheels may rotate rapidly (for example, when travelling at 60 mph with tires with an effective rolling radius of 318 mm, the wheels may be rotating at 5055 rpm) and thus any small imperfection of the tire or the wheel, for example the equivalent of an off-center mass of 10 g added to the rim in one spot, may result in a significant vertical force disturbance that may be applied to the unsprung mass. For this reason, wheels are often balanced using small counter-masses, and sometimes force balanced using the total measured force between the wheel and a measurement device. In some embodiments, one or more wheels may remain unbalanced, and as they rotate, this imbalance may induce oscillations in the force applied to the tire and suspension. An imperfection in the mass distribution on the wheel or rim, for example due to a curb strike that slightly bends the rim, may cause a force change in the vertical load every time that spot on the rim may be near the road. In some embodiments, any imbalance of mass on the tire or wheel, for example, which may result from the loss of one or more counterweights applied by technicians when installing the tires, may cause a force directed to the center of the wheel (centripetal force) which depends quadratically on the rotational speed, and which may point upward in the vertical direction once per revolution of the wheel. These types of force inputs may thus be appearing at a frequency that may be proportional to the driving speed of the vehicle, and that may be proportional to the amount of imperfection present on each wheel.

The Inventors have recognized that the amount of imperfection at each wheel may be estimated by analyzing the spatial frequency (the inverse of the wavelength as a function of travel distance) content of the vertical acceleration of each wheel. In some embodiments, the frequency content of the vertical acceleration of each wheel as a function of time may be analyzed. The Inventors have recognized that both quantities may be used as a diagnostic, for example, to determine the state of certain components in the vehicle. For example, a large change in tire hop frequency, for example a change of 1 Hz or more, may be an indication of a tire problem, while a large change in the imbalance on a given wheel might require a repair and might be a leading indicator to possible damage to the tire or tread that could lead to a blowout. In addition, this information may be used to provide an indication to the driver or vehicle controller about which speed may be optimal for comfort, since an unbalanced wheel driven at a speed that excites its natural frequency may be a cause for appreciable shake in the vehicle that may be noticed by the occupants. Inventors have recognized that under certain conditions driving either faster or slower may effectively reduce this discomfort.

In some embodiments, one or more systems in a vehicle may report to a customer, vehicle occupant, and/or to the vehicle owner or operator, about the ride quality experienced on a given trip. This may be done in multiple ways, for example: first, by analyzing measured vehicle motion, second, by analyzing the road profile traversed by the vehicle based on the known shape of the road or the estimated shape of the road as seen by the vehicle, and third, advantageously by comparing the measured vehicle motion to the expected motion based on the road content traversed and on a model of the vehicle's optimal behavior. This may allow for an estimate of the vehicle's condition and an estimate of any deterioration in the vehicle, as well as for an estimate of the discomfort experienced by the occupants. It may allow for an estimate of the amount of vibration experienced by the cargo, which may be an indication of quality for special types of cargo, for example, for fresh produce or fragile electronics. This method may also be applied inherently, as described above, to provide optimal route guidance based on expected road content at a given speed, and an estimate of the expected effects of that on a given cargo being carried. For example, a cargo of fresh strawberries might be particularly susceptible to vibration levels that lead to damage of the fruit. In some embodiments, inventors have recognized that knowing the road profile, the expected driving speed, and an at least estimated model of the vehicle, the levels of vibration that the cargo may be exposed to while traveling over a given route may be estimated a priori. In some embodiments, such information may also be used to provide intelligent route guidance to optimally preserve the cargo.

In some embodiments, a generic driver profile may be created based on one or more possible inputs. For example, a driver profile may generically be tailored to the vehicle being driven (for example, a sports car may have a more aggressive starting driver profile than a compact car); the driver may provide identification in the form of a login or some other form of identification, such as for example facial recognition, fingerprint ID, or a connection to a mobile phone, to access a stored personalized profile; and a pre-programmed setting may take external information into account, such as for example, time of day, the type of road being driven, environmental factors such as weather, and historic data based on commute routes and typical drives.

The driver profile may be designed to store personal (or general) preferences related to comfort, relative importance of total travel time against other factors such as comfort, vehicle wear or damage, and other factors listed above. This information may be expressly provided by a driver or occupant of the vehicle or collected automatically by the vehicle sensors during previous trips.

In some embodiments, actual current conditions and driver behavior may be used to modify, update, or generate a driver profile for the current driver. Multiple observations and measured entities may be considered. For example, if the driver switches lanes often, drives at speeds higher than usual or higher than most other drivers, or indicates in other ways that they are trying to get to their destination quicker, then travel time may automatically be prioritized over comfort. Similarly, using a driver's or other occupants' identities or logon credentials, and/or their electronic calendar, the navigation assistance controller or other microprocessor based controller may take into account when and where the next calendar event happens, and ask to, or automatically, modify the driver's preferences to relatively increase or decrease the prioritization of travel time in favor of other considerations such as comfort, toll cost, motion sickness, or vehicle wear or damage. Alternatively, if the driver may be assumed to be commuting to or from work based on the time of day, the travel direction, and/or location, then, for example, the importance of wear or cumulative vehicle damage may be relatively increased or reduced in priority over travel time, while during a long-distance trip, the importance motion sickness mitigation and comfort may be increased.

In some embodiments, one or more of the methods described above may be combined. Multiple factors presented above may be combined into a single metric that allows the system to rank travel routes and select the optimal one according to such a combined metric.

In some embodiments, a metric may be based on a combination of multiple factors. Each factor may be scaled to a 0-1 relative scale with 1 being a value that is considered the highest, and 0 being a value that is considered the lowest. For example, when considering tire wear, a scaling factor of 0 may be assigned to road content that will not cause noticeable increase in tire wear above a completely flat road, for example a road with very low content near tire hop frequencies, while a scaling factor of 1 may be used for a road that may accelerate tire degradation by a factor between 1.5 and 3. Additionally or alternatively, in some embodiments, a factor relative to motion sickness could be 0 for a flat road, or when none of the occupants are susceptible to motion sickness, and 1 for a road that is likely to induce frank sickness within a half hour of driving in, for example, at least one occupant. The scales for each factor may be set by, for example, the system designer, or by the manufacturer of the vehicle, or by the manufacturer of the road profile tool. In some embodiments, a relative weighting may be applied to one or more factors. This weighting may be based on considerations such as described above, of knowledge of the type, state, and history of the given vehicle and its components, and on considerations regarding a generic and sometimes also specific driver profile. In some embodiments, by using a weighting for each value and multiplying the weighting by the scaled number for each factor and summing the total factors, a total number may be determined for each road segment. In this manner, an optimized route planning may be achieved where the optimum may be determined based on a subset of several factors, each with a weighting factor that may be modified based on personal preferences or some of the considerations described above. In some embodiments, this total number may be used as a metric to rank road segments relative to each other, and to select the route that has the lowest total score as optimal for the current driver, vehicle, road conditions, and traffic and/or current situation.

In some embodiments, multiple pre-selected combination of weightings may be presented to a driver, via for example, a user interface, or a graphical interface in the vehicle or on a device such as a cell phone, as a choice, combined for example to prioritize driving fun (thus for example weighting high curvature and high speed roads as important factors, and comfort and motion sickness as less important), comfort (for example weighting comfort and motion sickness as important, and travel time as less important), economy (for example weighting fuel consumption and component wear as important, and other factors lower), or even combinations targeted to specific objectives such as “I'm late” (prioritizing travel time over all else) or “I'm tired” (prioritizing roads with less curvature and fewer turns).

In some embodiments, weighting may be set by the consumer, for example, via a user interface or cell phone, for each factor, or for groups of factors, in an individualized way, and these weights may be stored in a user profile or be applied only to the current drive session, based on user choice or instruction.

Some factors that may be considered are listed above, but it is understood that other factors may also be considered. Among the factors listed above are travel time, traffic conditions (current or expected), local weather conditions, road surface grip and expected grip at the expected driving speed, recommended speed (as opposed to speed limits or current traffic speed), traffic lights, cross-lane turns (left turns in countries like the USA), pedestrian crossings, tolls, narrow or low clearance roads, spatial frequency road content, expected comfort level, history of comfort over the current drive, expected component wear, current state of component wear, number and type of road events, general discomfort, fuel consumption, motion sickness incidence, ground clearance issues, road curvature, expected lateral acceleration due to road shape and road camber, wheel imbalance and the propensity of each road to excite it at the currently expected driving speed, cargo type and sensitivity of that cargo to vibration, generic driver profile, and current driver profile or modifications, as well as customer preferences.

In some embodiments, a cost function may be used to quantify the occurrence and/or severity of certain undesirable effects associated with traveling along a route from a first point to a second point. The undesirable effects may include, but are not limited to, motion sickness, vehicle component wear (e.g., tire wear, bushing wear, and damper wear), and inefficiency. When a vehicle with occupants travels on a road surface, a cost function may be associated with the operation of the vehicle. Such a cost function may be related to or a function of: (i) road specific data, e.g., road surface data and/or risk factors, (ii) vehicle specific data, such as, for example, transfer functions or models of a vehicle's suspension system, braking system, steering system or wear models of various components such as springs, dampers bushings or tires. Cost functions may be developed in the laboratory, through computer simulation, based on crowd-sourced data and/or information provided by component or vehicle manufacturers. When faced with choosing between several routes to travel between a first point and a second point, the route selected may be the route with the lowest cost function.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

1. A method of operating a vehicle, the method comprising:
receiving information about at least two routes between a first location and a second location;
receiving vehicle-specific information about the vehicle;
selecting a route from among the at least two routes, wherein the selection is based at least partially on the information about the at least two routes and the vehicle-specific information; and
traveling along the selected route with the vehicle.

2. The method of claim 1, wherein the at least two routes include a first route and a second route, and wherein the first route and the second route at least partially overlap with each other.

3. The method of claim 1, wherein the information about the at least two routes includes road surface data.

4. The method of claim 3 further comprising receiving information about a location of the vehicle, wherein the location of the vehicle is determined using a localization system selected from the group consisting of GNSS and a terrain-based localization system.

5. The method of claim 4, wherein the location of the vehicle is the first location.

6. The method of claim 1, wherein the vehicle is selected from a group consisting of an autonomous vehicle, a semi-autonomous vehicle, and a manually driven vehicle.

7. The method of claim 1, wherein the vehicle-specific information includes information about a transfer function of a suspension system of the vehicle.

8. The method of claim 7, wherein the suspension system of the vehicle is an active suspension system.

9. The method of claim 1, wherein the vehicle-specific information includes information about a position of a center of gravity of the vehicle.

10. The method of claim 1, further comprising receiving information about a projected speed of the vehicle when traveling along at least a portion of the at least two routes.

11. The method of claim 10, further comprising determining projected road induced disturbances while traversing the at least two routes at least partially based on the information about the at least two routes and the projected speed of the vehicle while traversing at least portions of the at least two routes, wherein the selecting the route is also at least partially based on the projected road induced disturbances.

12. The method of claim 11, wherein the vehicle-specific information includes information about a weight of the vehicle.

13. The method of claim 1, wherein the vehicle-specific information includes information about at least one vehicle occupant.

14. The method of claim 13, wherein the information about the at least one vehicle occupant includes information about a sensitivity of the at least one vehicle occupant to motion sickness.

15. The method of claim 13, wherein the information about the at least one vehicle occupant includes information about a sensitivity of the at least one vehicle occupant to motion sickness, while performing an activity selected from a group consisting of reading and manipulating a computer mouse.

16. The method of claim 13, wherein the vehicle-specific information includes information about a projected activity, by the at least one vehicle occupant.

17. The method of claim 1, further comprising, based at least partially on the information about the at least two routes and the vehicle-specific information, determining a speed range of operation while traveling along the selected route, and traveling on the route at the speed range of operation.

18. A method of operating a vehicle, the method comprising:
receiving information about at least two routes between a first location and a second location, wherein the information about at least two routes includes road surface information;
receiving information from a user interface;
selecting a route from among the at least two routes, wherein the selection is based at least partially on the information received about at least two routes and the information from the user interface; and
traveling along the selected route, with the vehicle.

19. The method of claim 18, wherein the user interface is on-board the vehicle.

20. The method of claim 18, wherein the information received from the user interface includes an indication that reduction of tire-wear is a preference.

21. The method of claim 18, wherein the information received from the user interface includes an indication that reduction of motion sickness is a preference.

22. The method of claim 18, wherein the information received from the user interface includes an indication that reduction of lateral acceleration of a vehicle body is a preference.

23. The method of claim 18, wherein the information received from the user interface includes an indication that reduction of vertical acceleration of a vehicle body is a preference.

24. The method of claim 20, further compromising selecting a speed for at least a portion of the selected route.

25. The method of claim 20, further compromising selecting a maximum speed for at least a portion of the selected route.

26. The method of claim 20, further compromising selecting a minimum speed while traveling along at least a portion of the selected route.

27. The method of claim 18, wherein selecting the route includes selecting a lane in a multilane portion of the selected route.

28. (canceled)

29. The method of claim 18 wherein the information received about the at least two routes includes crowd sourced information.

30. A method of operating a vehicle, the method comprising:
receiving information about at least two routes between a current location and a destination;
receiving vehicle-specific information about the vehicle;
based on the information received about the at least two routes and the vehicle-specific information, selecting a route from among the at least two routes in order to achieve an effect selected from a group consisting of less component wear, less motion sickness, shorter travel time, higher energy efficiency; and
traveling along the selected route.
